(19) United States
(12) Patent Application Publication
(10) Pub. No.: US 2026/0100605 A1
(43) Pub. Date: Apr. 9, 2026

(54) COIL FOR WIRELESS POWER TRANSFER

(71) Applicant: Solace Power Inc., Mount Pearl (CA)

(72) Inventors: Christopher Thomas SEARY, Mount Pearl (CA); Rasool KAHANI, St. John's (CA)

(73) Assignee: Solace Power Inc., Mount Pearl (CA)

(21) Appl. No.: 19/350,659

(22) Filed: Oct. 6, 2025

Related U.S. Application Data
(60) Provisional application No. 63/704,185, filed on Oct. 7, 2024.

(51) Int. Cl. H02J 50/00; H01F 41/06; H02J 50/05; H02J 50/40; H02J 50/70

(52) U.S. Cl. CPC H02J 50/005; H01F 41/06; H02J 50/05; H02J 50/402; H02J 50/70

(57) ABSTRACT

There is provided a coil for wireless power transfer. The coil comprises a continuous wire strand forming multiple windings in a plane of a printed circuit board (PCB). The multiple windings comprise an innermost winding and an outermost winding enclosing the innermost winding. The coil further comprises at least one electrical connection to another continuous wire strand forming multiple windings in another plane of the PCB. The electrical connection is located intermediate the innermost winding and the outermost winding.

### CROSS-REFERENCE TO RELATED APPLICATIONS

This application claims the benefit of U.S. Provisional Application No. 63/704185 filed Oct. 7, 2024, and titled COIL FOR WIRELESS POWER TRANSFER, the entirety of which is incorporated herein by reference.

### FIELD

The subject disclosure relates generally to wireless power transfer, and in particular to a coil for wireless power transfer.

### BACKGROUND

Wireless power transfer systems such as wireless charging are becoming an increasingly important technology to enable the next generation of devices. The potential benefits and advantages offered by the technology is evident by the increasing number of manufacturers and companies investing in the technology.

A variety of wireless power transfer systems are known. A typical wireless power transfer system includes a power source electrically connected to a wireless power transmitter, and a wireless power receiver electrically connected to a load.

In magnetic wireless power systems, the transmitter has a transmitter coil with a certain inductance that transfers electrical energy from the power source to the receiver, which has a receiver coil with a certain inductance. Power transfer occurs due to coupling of magnetic fields between the coils or inductors of the transmitter and receiver. Such an inductive system may be non-resonant or resonant. In resonant magnetic induction the inductors are resonated using capacitors. The range of power transfer in resonant magnetic systems may be increased over that of non-resonant magnetic induction systems and alignment tolerances may be improved.

In electric wireless power systems, the transmitter and receiver have capacitive electrodes. Power transfer occurs due to coupling of electric fields between the capacitive electrodes of the transmitter and receiver. Similar to resonant magnetic wireless power systems, there exist resonant electric wireless power systems in which the capacitive electrodes of the transmitter and receiver are resonated using inductors, i.e., coils. Resonant electric systems may have an increased range of power transfer compared to that of non-resonant electric wireless power systems and alignment tolerance may be improved.

While some wireless power transfer systems are known, improvements are desired. It is therefore an object to provide a cooling arrangement for a wireless power transfer system, wireless power transfer system and/or method of cooling a receiver.

This background serves only to set a scene to allow a person skilled in the art to better appreciate the following description. Therefore, none of the above discussion should necessarily be taken as an acknowledgement that the discussion is part of the state of the art or is common general knowledge. One or more aspects/embodiments of the invention may or may not address one or more of the background issues.

### SUMMARY

According to an aspect there is provided, a coil for wireless power transfer, i.e., for use in a wireless power transfer system either as part of a transmitter or a receiver of the wireless power transfer system. The described coil may improve the wireless power transfer efficiency of the system. The described coil may be utilized for a broader range of applications, e.g., higher inductance applications, and/or higher frequency applications, than conventional coils.

According to another aspect, there is provided a coil for wireless power transfer. The coil may be a magnetic field induction coil. The coil may be a printed circuit board (PCB) coil in that the coil is formed on a PCB. The coil may comprise or solely consist of:
multiple continuous strands (i.e., wire strands), each strand having multiple turns or windings in a single PCB layer. In other words the windings may be confined to a single PCB layer, e.g., horizontal layer of the PCB. The wire strand may be located in separate and distinct PCB layers. The PCB layers may be parallel in a direction, e.g., a vertical Z-axis. The strands together may form a planar wire, e.g., a planar Litz wire. No electrical connection may be present between strands. Furthermore, the number of vias within each strand may be minimized. As vias (i.e., electrical connections) generally add resistance and/or losses, this may the coil's electrical properties.

The strands may have multiple turns in the same direction. In other words, a first strand may comprise multiple turns in a first direction, e.g., clockwise, and a second strand may comprise multiple turns in the same first direction. Alternatively, the second strand may comprise multiple turns in a second direction opposite the first direction, e.g., counter clockwise.

The turns or windings may cross each other within a layer of the PCB. In other words, the turns may have strand crossing or lane swaps within a layer with an underlying or overlaying layer. Each turn may comprise at least one lane swap in the single PCB layer.

According to another aspect, there is provided a coil for wireless power transfer, the coil comprising:
a continuous wire strand forming multiple turns or windings in a plane of a printed circuit board (PCB), the multiple windings comprising an innermost winding and an outermost winding enclosing the innermost winding; and
at least one electrical connection to another continuous wire strand forming multiple windings in another plane of the PCB, the electrical connection located intermediate the innermost winding and the outermost winding.

The coil may comprise only one or only two electrical connections, e.g., vias, between strands. As such, the number of vias may be reduced compared to conventional coils thereby improving electrical properties of the coil, and/or efficiency of a wireless power transfer system utilising the coil.

Further, as the electrical connections, e.g., vias, are located intermediate the innermost and outermost turns, an impedance of the strand and the other continuous wire strand may be at least partially balanced. This may improve the electrical properties of the coil, and/or efficiency of a wireless power transfer system utilising the coil.

The continuous wire strand may comprise a strand of Litz wire. The wire strand along with the other wire strand may form a wire, e.g., a Litz wire. The wire strands may form a planar wire, e.g., a planar Litz wire. The wire strands may form a wire on the PCB.

The strand may be confined to a single PCB layer. The PCB layer may be a plane of the PCB, e.g., a horizontal plane. The other strand may be confined to another PCB layer. The other PCB layer may be another plane of the PCB, e.g., another horizontal plane. The planes may be parallel.

The electrical connection may connect the strands. The electrical connection may be a connection between layers of the PCB. The electrical connection may be the only connection between the strands in the separate and distinct layers of the PCB.

The coil may further comprise the other continuous wire strand. The strands may form a wire, e.g., a planar wire. The planar wire strand may be a planar Litz wire.

The coil may further comprise the PCB.

The coil may consist of, i.e., only include, the described wire strands, electrical connection, and PCB.

A position of the electrical connection may be selected such that areas of the windings or turns of the continuous wire strand preceding and following the position are approximately equal. In this context, preceding and following refer to the portion of the strand from the position to one end terminal of the strand, and the portion of the strand from the position to another end terminal of the strand. In other words, the position of the electrical connection may be at an approximate midpoint of the strand. Additionally, the position of the electrical connection may be at an approximate midpoint of the strand and other strand.

The continuous wire strand may comprise at least one lane swap in the plane of the PCB. A lane swap or Litz strand crossing represents points at which the turn crosses an underlying or overlaying wire strand in another plane. Each turn may comprise at least one lane swap. Each turn may comprise multiple lane swaps. Each turn may comprise four lane swaps.

The strands may comprise lane swaps which at least partially overlay or underlay a lane swap in another layer of the PCB. For example, the strand may comprise a lane swap in a plane of the PCB which at least partially overlays a lane swap of the other strand in the other layer of the PCB. Similarly, the other strand may comprise a lane swap in the other plane which at least partially underlays a lane swap of the strand in the plane.

Each winding may comprise at least one lane swap. Each lane swap may reduce or increase a radius of at least one winding of the continuous wire strand.

Adjacent lane swaps may alternatively reduce and increase the radius of at least one winding of the continuous wire strand.

The strands may have multiple turns in the same direction. In other words, the strand may comprise multiple turns in a first direction, e.g., clockwise, and the other strand may comprise multiple turns in the same first direction. Alternatively, the other strand may comprise multiple turns in a second direction opposite the first direction, e.g., counter clockwise.

The electrical connection may comprise at least one via. The electrical connection may comprise multiple vias. The vias may be parallel in a plane perpendicular to the plane of the PCB. For example, the vias may be parallel in the vertical direction, e.g., Z-axis.

The coil may comprise:
a first continuous wire strand forming multiple windings in a first plane of the PCB, the multiple windings in the first plane comprising an innermost winding and an outermost winding enclosing the innermost winding; and
a second continuous wire strand forming multiple windings in a second plane of the PCB, the multiple windings in the second plane comprising an innermost winding and an outermost winding enclosing the innermost winding.

Each plane of the PCB may represent a different layer of the PCB. In other words, the first continuous wire strand may have multiple windings in a first layer of the PCB, and the second continuous wire strand may have multiple windings in a second layer of the PCB. The first and second layers may be parallel in a vertical direction, e.g., Z-axis.

The first and second strands may form a wire. For example, the first and second strands may form a planar wire, e.g., a planar Litz wire. Thus, the strands may comprise Litz strands.

The electrical connection may connect the first continuous wire strand to the second continuous wire strand. The electrical connection may be a layer swap between the first and second plane or layers of the PCB.

The strands remain separate from each other within the electrical connection (layer swap). An outer winding of the first strand in the first layer of the PCB (e.g., a top layer) connects to an inner winding of the first strand in the second layer of the PCB (e.g., a bottom layer). An outer winding of the second strand in the second layer of the PCB (e.g., the bottom layer) connects to an inner winding of the second strand in the first layer of the PCB (e.g., the top layer). In this context, inner and outer refer to the relative positions of the windings or turns in the first or second planes. In other words, the outer winding had a greater radius than the inner winding, and the inner winding has a lesser radius than the outer winding.

The electrical connection may be located intermediate the innermost, and the outermost windings of the first continuous wire strand. The electrical connection may also be located intermediate the innermost, and the outermost windings of the second continuous wire strand.

A distance between the first and second wire strands in the first or second plane is less than an absolute distance between the first and second wire strands. In other words, a horizontal separation between the strands may be less than a diagonal separation distance between the strands. This may provide improved electrical properties of the coil. This may minimize the self-capacitance of the coil. This may improve performance of a wireless power transfer system utilizing the coil. In particular, this may improve performance of a wireless power transfer system at higher frequencies.

The first continuous wire strand may comprise at least one first lane swap in the first plane of the PCB. The second continuous wire strand may comprise at least one second lane swap in the second plane of the PCB.

The first lane swap may at least partially overlay the second lane swap.

The coil may have a generally square, rectangular, or circular shape. The square or rectangular shape may have rounded edges. The turns or windings of the strands may have a generally square, rectangular, or circular shape. The square or rectangular turns or windings may have rounded edges. One of skill in the art will appreciate, the coils or turns are not limited to the described shapes, and may have other shapes such as semicircular or triangular.

According to another aspect, there is provided a transmitter for wirelessly transferring power to a receiver of a wireless power transfer system. The transmitter may comprise any of the described coils. The coil may be for generating a field for transferring power to a receiver of a wireless power transfer system.

The transmitter may further comprise a power source electrically connected to the coil. The power source may provide an AC power signal to the coil.

The transmitter may comprise a DC/AC inverter. The inverter may be for converting an input DC power signal to an output AC power signal. The inverter may be electrically connected to the coil. The inverter may be electrically connected between the power source, and the coil.

The transmitter may comprise a DC/DC converter. The converter may convert an input DC power signal to an output DC power signal having a desired voltage level. The converter may be electrically connected between the power source, and the inverter.

The transmitter may further comprise:
a shield adjacent to the coil and configured to encompass the coil to at least partially eliminate environmental influences affecting the coil.

The shield may be located in a plane adjacent and parallel to the plane of the wire strand, and/or adjacent and parallel the described first and second planes. The shield may located on one side of the coil, while the coil transfers power to a receiver coil on the other side of the coil.

The position of the electrical connection may be selected such that areas of the windings of the continuous wire strand preceding and following the position are approximately equal as described. The equal areas before and after the electrical connection, i.e., layer swap, may balance the effect of the shield on the strands of the coil, i.e., the first and second strands. In particular, this may balance the effect of the shield on the strands.

According to another aspect, there is provided a receiver for wirelessly extracting power from a field generated by a transmitter of a wireless power transfer system. The receiver may comprise any of the described coils. The coil may be for extracting power from a field generated by a transmitter of a wireless power transfer system.

The receiver may further comprise a load electrically connected to the coil.

The receiver may further comprise an AC/DC rectifier for converting an input AC signal to an output DC signal. The rectifier may be electrically connected between the coil and the load.

The receiver may further comprise a DC/DC converter. The converter may convert an input DC power signal to an output DC power signal having a desired voltage level. The converter may be electrically connected between the rectifier and the load.

The receiver may further comprise:
a shield adjacent to the coil and configured to encompass the coil to at least partially eliminate environmental influences affecting the coil.

The shield may be located in a plane adjacent and parallel to the plane of the wire strand, and/or adjacent and parallel the described first and second planes. The shield may located on one side of the coil, while the coil extracts power to field generated by a transmitter coil on the other side of the coil.

The position of the electrical connection may selected such that areas of the windings of the continuous wire strand preceding and following the position are approximately equal as described. The equal areas before and after the electrical connection, i.e., layer swap, may balance the effect of the shield on the strands of the coil, i.e., the first and second strands. In particular, this may balance the effect of the shield on the strands.

According to another aspect, there is provided a wireless power transfer system comprising:
a transmitter comprising any of the described coils; and
a receiver comprising any of the described coils.

The coils of the transmitter and receiver may be separated by a gap. A medium may be present in the gap. The medium may comprise a physical medium, e.g., walls, glass, liquids, wood, insulations, etc. The coil of the receiver may be placed proximate or on one surface of the medium, while the coil of the transmitter may be placed proximate or on another opposite surface of the medium. The coils may be aligned relative to the medium to maximize wireless power transfer efficiency.

According to another aspect, there is provided a method of forming a coil for wireless power transfer, the method comprising:
forming a first continuous wire strand having multiple windings in a first plane of a PCB, the multiple windings comprising an innermost winding and an outermost winding enclosing the innermost winding.

The method may further comprise:
forming a second continuous wire strand having multiple windings in a second plane of the PCB, the multiple windings comprising an innermost winding and an outermost winding enclosing the innermost winding.

The first and second strands may form a planar wire, e.g., a planar Litz wire.

The method may further comprise:
forming at least one electrical connection at a location intermediate the innermost winding and the outermost winding for connecting the wire strand to another continuous wire strand having multiple windings in another plane of the PCB. The electrical connection may be between the first and second strands.

The strands may be formed in a process that is specifically for printing circuit boards, e.g., PCB.

According to another aspect, there is provided a method of wirelessly transferring or extracting power. The method may comprise:
resonating any of the described coils to generate a field to transfer power to a receiver of a wireless power transfer system; and/or
resonating any of the described coils to extract power from a field generated by a transmitter of a wireless power transfer system.

The method may comprise both resonating the described coil of a transmitter to generate a magnetic field, and resonating the described coil of a receiver to extract power from the generated magnetic field.

It should be understood that any features described in relation to one aspect, example or embodiment may also be used in relation to any other aspect, example or embodiment of the present disclosure. Other advantages of the present disclosure may become apparent to a person skilled in the art from the detailed description in association with the following drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments will now be described more fully with reference to the accompanying drawings in which:

FIG. 1 is a block diagram of a wireless power transfer system;

FIG. 2a is a perspective view of a portion a wireless power transfer system;

FIG. 2b is a front elevation view of the portion of FIG. 2a;

FIG. 3 is a plan view of a coil for wireless power transfer according to an aspect of the disclosure;

FIG. 4a is a plan view of a coil for wireless power transfer according to an aspect of the disclosure;

FIG. 4b is an enlarged view of a portion ‘A’ of the coil of FIG. 4a;

FIG. 4c is a cross-sectional perspective view of a portion of the coil of FIG. 4a;

FIG. 5 is a plan view of a coil for wireless power transfer according to an aspect of the disclosure;

FIG. 6 is a plan view of a portion of a wireless power transfer system;

FIGS. 7a-7d are graphs of wireless power transfer efficiency relative to load for wireless power transfer systems at various separation distances; and

FIG. 8 is a plan view of a strand pattern of a coil for wireless power transfer according to an aspect of the disclosure.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings. It will also be appreciated that like reference characters will be used to refer to like elements throughout the description and drawings.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, and/or designed for the purpose of performing the function. It is also within the scope of the subject application that elements, components, and/or other subject matter that is described as being adapted to perform a particular function may additionally or alternatively be described as being configured to perform that function, and vice versa. Similarly, subject matter that is described as being configured to perform a particular function may additionally or alternatively be described as being operative to perform that function.

It will be understood that when an element is referred to as being “on,” “attached” to, “connected” to, “coupled” with, “contacting,” etc., another element, it can be directly on, attached to, connected to, coupled with or contacting the other element or intervening elements may also be present unless otherwise stated.

It should be understood that use of the word “exemplary”, unless otherwise stated, means ‘by way of example’ or ‘one example’, rather than meaning a preferred or optimal design or implementation.

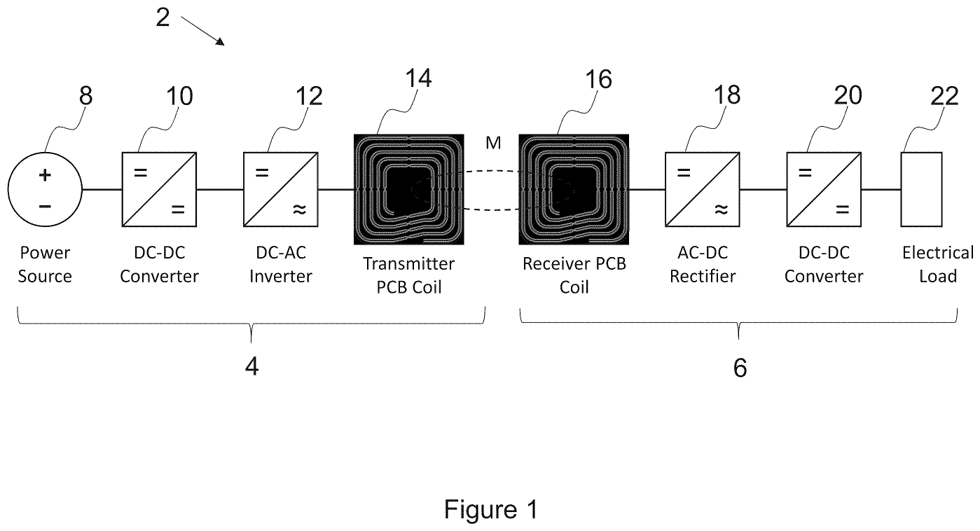

Turning now to FIG. 1, a wireless power transfer system generally identified by reference numeral 2 is shown. The wireless power transfer system 2 comprises a transmitter 4, and a receiver 6. The transmitter 4 comprises a power source or supply 8, a DC/DC converter 10, a DC/AC inverter 12, and a transmitter coil 14. The power supply 8 is electrically connected to the DC/DC converter 10. The DC/DC converter 10 is electrically connected to DC/AC inverter 12. The DC/AC inverter 12 is electrically connected to the transmitter coil 14. One of skill in the art will appreciate the DC/DC converter 10 may be omitted.

The power supply 8 is for generating an input power signal for transmission of power. In this embodiment, the input power signal is a direct current (DC) power signal. The DC/DC converter 10 is for converting a received DC voltage signal to a desired voltage level. The received DC voltage may be from the power supply 8. The DC/AC inverter 12 is for inverting a received DC signal to a desired AC signal. The received DC signal may be from the DC/DC converter 10 or directly from the power source 8 if no DC/DC converter 10 is present/required.

The receiver 6 comprises a receiver coil 16, an AC/DC rectifier 18, a DC/DC converter 20, and a load 22. The receiver coil 16 is electrically connected to the AC/DC rectifier 18. The AC/DC rectifier 18 is connected to the DC/DC converter 20. The DC/DC converter 20 is connected to the load 22. In the illustrated arrangement, the load 22 is a DC load. The load 22 may be static or variable. One of skill in the art will appreciate the DC/DC converter 20 may be omitted.

The AC/DC rectifier 18 is for rectifying/converting a received AC voltage signal to a DC voltage signal. The received AC voltage signal may be from the receiver coil 16. The DC/DC converter 20 is for converting a received DC voltage signal to a desired voltage level.

Exemplary wireless power transfer systems 10 include a high frequency inductive wireless power transfer system as described in applicant's U.S. Pat. No. 11,817,834B2, the relevant portions of which are incorporated herein by reference.

The coils 14, 16 may include booster or shield coils such as described in applicant's US Patent Application Publication No 2021/0281122 A1, the relevant portions of which are incorporated herein by reference.

During operation, power is transferred from the power source 8 to the coil 10 after it is converted by the DC/DC converter 10 and inverter/converted to AC by the DC/AC inverter 12. Power is transferred from the transmitter coil 14 to the receiver coil 16 via resonant or non-resonant magnetic field coupling. Power is transferred from the receiver coil 16 to the load 22 after it is rectified by the AC/DC rectifier 18 and converted by the DC/DC converter 20. The receiver coil 16 extracts power from a magnetic field generated by the transmitter coil 14. The magnetic field is identified as reference symbol M. The AC/DC rectifier 18 rectifies the received power signal. The DC/DC converter 20 converts the rectified power signal to the desired voltage level which is received by the load 22. In this way, the receiver coil 16 extracts power transmitted by the transmitter coil 14 such that electrical power is transferred to the load 22 via magnetic field coupling.

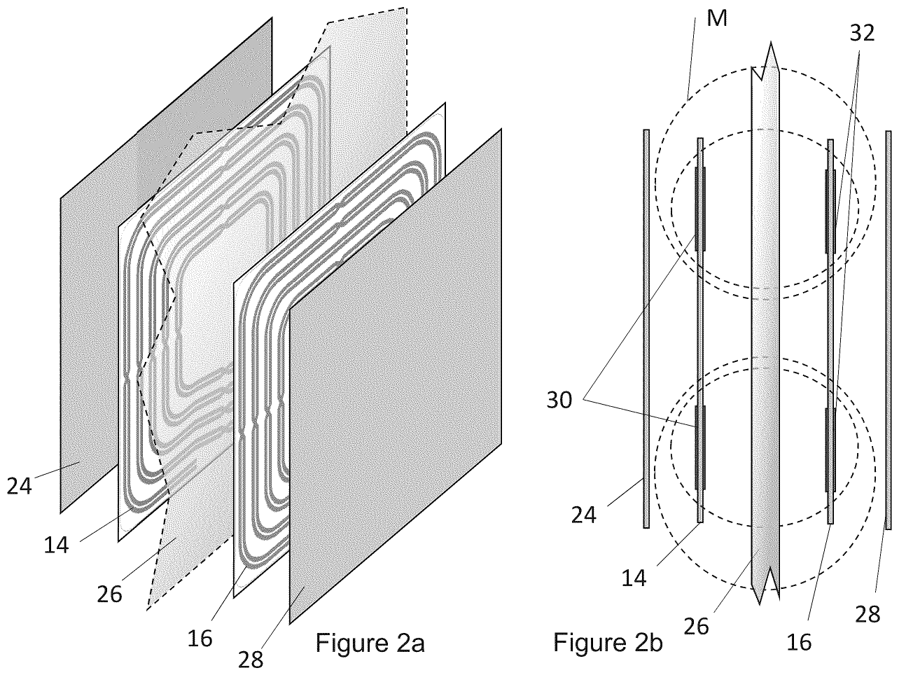

The coils 14, 16 of the system 2 are separated by a gap. The gap may be formed by atmosphere, i.e. air, or by a physical medium, e.g., walls, glass, liquids, wood, insulations, etc. As illustrated in FIGS. 2a and 2b, the gap may be formed by a medium 26. The coils 14, 16 may be adjacent opposite surfaces of the medium 26. In particular, the coils 14, 16 may be placed on opposite surface of the medium 26. The coils 14, 16 may transfer power through the medium 26. The medium 26 may be, at least partially, in the form of an air-gap, or may at least partially be a physical medium such as glass, wood, concrete or other building supply. The wireless power transfer system 2 may be tuned for a particular medium, e.g., a thickness of the medium or a material property of the medium. A method, system, transmitter and receiver of transferring power through a medium is described in Applicant's own US Patent Application Publication No 2024/0213813 A1, the relevant portions of which are hereby incorporated by reference.

FIGS. 2a and 2b further illustrate shields 24, 28 adjacent the coils 14, 16 opposite the medium 26. In particular, a transmitter shield 24 is adjacent the transmitter coil 14 opposite the medium 26 in the X-axis. A receiver shield 28 is adjacent the receiver coil 16 opposite the medium 26 in the X-axis. Each shields 24, 28 may encompasses the respective coil 14, 16 to at least partially eliminate environmental influences affecting the coils 14, 16. Exemplary shields include those described in Applicant's U.S. Pat. No 11,139,690B2, the relevant portions of which are incorporated herein by reference.

As also illustrated in FIG. 2b, each coil 14, 16 comprises windings 30, 32. In particular, the transmitter coil 14 comprises transmitter windings 30, and the receiver coil 16 comprises receiver windings 32. These will be described in more detail below.

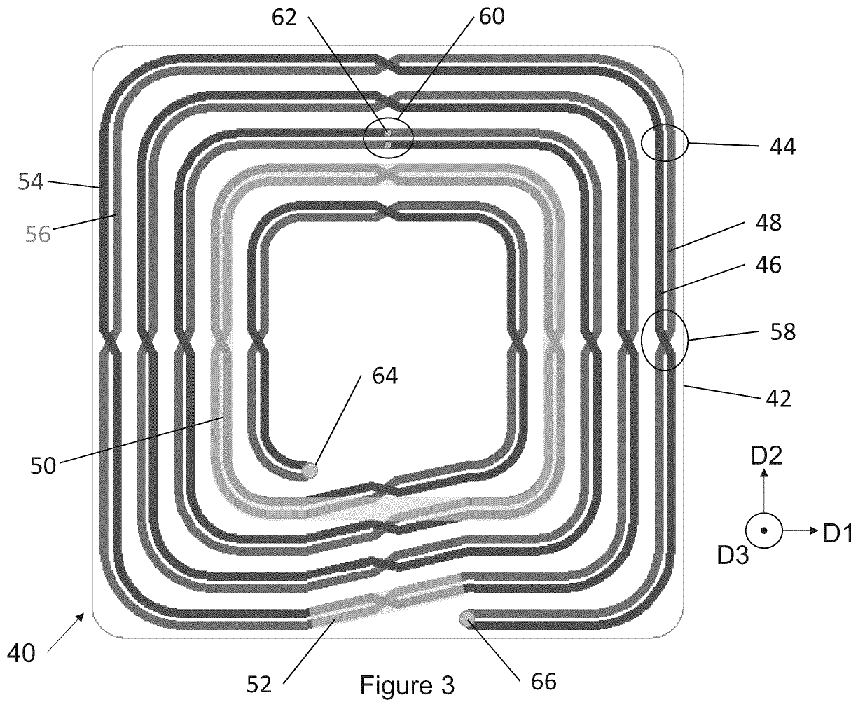

Turning now to FIG. 3, an arrangement of a coil 40 for wireless power transfer is illustrated. The described coils 14, 16 may take the form of the coil 40. As such, the coil 40 may be utilised to generate a magnetic field to transfer power, and/or extract power from a generated magnetic field via magnetic field coupling. The coil 40 comprises a planar Litz wire 44 formed on a PCB 42. In this arrangement, the Litz wire 44 comprises a first continuous wire strand 46, and a second continuous wire strand 48. The first continuous wire strand 46 is located in a first plane (top layer) 54 of the PCB 42, while the second continuous wire strand 48 is located in a second plane (bottom layer) 56 of the PCB 42. The first and second planes 54, 56 extend in first and second directions D1, D2, e.g., X-axis and Y-axis. The first and second planes 54, 56 are parallel in a third direction D3, e.g., Z-axis. The third direction D3 is perpendicular to the first and second directions D1, D2.

The planar Litz wire 44 comprises multiple turns or windings 50. In this arrangement, the turns are generally rectangular and have rounded edges. Each turn 50 includes both strands 46, 48. As such, the strands 46, 48 also comprises multiple turns 50. A single turn 50 is highlighted in FIG. 3. Additionally, a turn or winding change 52 is highlighted. A turn change 52 may be understood to refer to the start of one turn and the end of another turn. As illustrated in FIG. 3, an outermost turn encloses all other turns. That is to say, an outermost turn has the greater circumference and/or radius. All other enclosed turns have a lesser circumference and/or radius. An innermost turn has a smallest circumference and/or radius.

In the illustrated arrangement, the coil 40 comprises five turns 50; however, one of skill in the art will appreciate that more or fewer may be present. Further, one of skill in the art will appreciate that more layers may be present beyond the two layers illustrated.

Each strand 46, 48 is confined, i.e., is located in, a single PCB layer. For example, the first continuous wire strand 46 which comprises multiple turns 50 is confined to the top layer or first plane 54. The second continuous wire strand which comprises multiple turns is configured to the bottom layer or second plane 56.

Further, rather than twisting around each other completely, as may be done in a related art, each strand 46, 48 twist back and forth. This is identified as a lane swap or Litz crossing 58. As illustrated in FIG. 3, strand 46 has four lane swaps 58 in each turn 50. More or fewer lane swaps 58 may be present. In a lane swap 58, the radius of the respective turn 50 increases or decreases.

As the strands 46, 48 are simply swapping lanes and not layers, no electrical connections (e.g., vias) between strands 46, 48 are required. Vias generally add resistance and are lossy. The described lane swaps 58 preserve the maximum space between currents of the strands 46, 48 and balances the area between the strands 46, 48. Further, the lane swaps 58 allow for more turns 50 on each layer 54, 56. This results in a coil 40 which may be used for higher inductance applications. Lane swaps 58 of the strands 46, 48 are collocated so as to balance the area between the strands 46, 48.

If the described coil 50 in positioned in free space, having no vias results in a coil 40 having nearly equal impedance in the strands 46, 48. However, when the described shields 24, 28 are present, a strand, e.g., second continuous wire strand 48, on the bottom layer 56 closer to the respective shield 24 or 28 become more capacitive and less inductive. The difference in impedance between top and bottom layers 54, 56 results in unequal current sharing between strands 46, 48 and thus higher resistance of the planar wire 44.

However, this may be addressed by introducing vias in the coil 40. As vias may add resistance and be lossy, the number of vias introduced is minimized. In the illustrated arrangement, a layer swap 60, i.e. a connection between the top and bottom layers 54, 56 is introduced. In the illustrated arrangement, the layer swap 60 comprises two electrical connections, e.g., vias 62.

Consider that the first continuous wire strand 46 begins at an outermost radius of the coil 40 on the top layer 54. This part of the strand 46 has relatively high inductance and low parasitic capacitance due to its greater distance from the shield, e.g., shield 24. After some turns 50, the strand 46 swaps to the bottom layer 56 (via a via 62), where the strand 48 now has relatively low inductance and high parasitic capacitance. In total, the strand 46/48 has moderate impedance, so current will be shared equally between this strand 46/48 and the other strand 48/46.

Because parasitic capacitance is proportional to the area of conductors, the location of the layer swap 60 is selected such that half the area of the strand 46 is on the top layer 54, and the other half is on the bottom layer 56. Via simulation, a benefit is observed when the layer swap 60 is located approximately halfway through the turns 50 of the coil 40 as compared to the same coil 40 with no layer swap 60. In the illustrated arrangement, the layer swap 60 may be located after approximately half the turns, e.g., after 2.5 turns in the 5-turn coil 40 illustrated in FIG. 3.

As illustrated in FIG. 3, the coil 40 comprises a layer swap 60 having two electrical connections, e.g., via 62. One of skill in the art will appreciate that more vias, e.g. 6, may be present. The vias are parallel, e.g., parallel in the third direction D3.

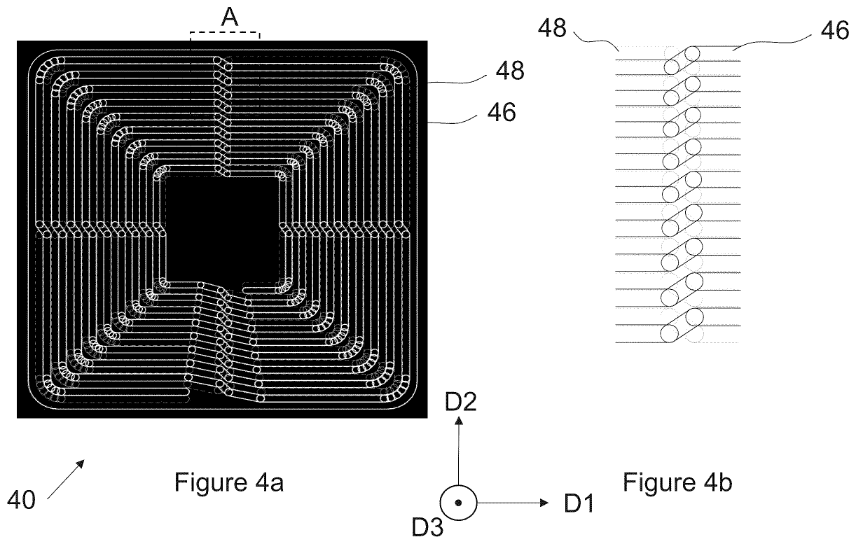

Turning now to FIGS. 4a-4c, views of a coil for wireless power transfer are illustrated. FIG. 4a illustrates the coil 40 with the first continuous wire strand 46 illustrated in unbroken lines, and the second continuous wire strand 48 illustrated in broken lines. This clearly illustrates that the strands 46, 48 are present in two different layers/planes 54, 56 of the PCB 42. FIG. 4b is an enlarged view of a portion ‘A’ of the coil 40 illustrated FIG. 4a. The second continuous wire strand 48 is illustrated in broken lines.

FIG. 4c is a cross-sectional perspective view of a portion of the coil 40. The top layer 54 of the PCB 42 is illustrated as including the first continuous wire strand 46, while the bottom layer 56 of the PCB 42 includes the second continuous wire strand 48. The strands 46, 48 are present in a first turn 50a, and a second turn 50b of the previously described turns 50.

The area available for the coil 40 may be utilised such that the strands 46, 48 in the layers 54, 56 are overlapping without being shorted. This may minimize the self-capacitance of the coil 40 as the diagonal distance d1 between adjacent turns 50a, 50b, is greater than a horizontal distance h1. A low self-capacitance enables efficient operation at high frequencies. Thus, a coil 40 having a diagonal distance d1 between strands 46, 48 in adjacent turns 50a, 50b being greater than a horizontal distance h1 the between strands 46, 48 in adjacent turns 50a, 50b may be more efficient. In particular, the coil 40 may be more efficient at higher frequencies.

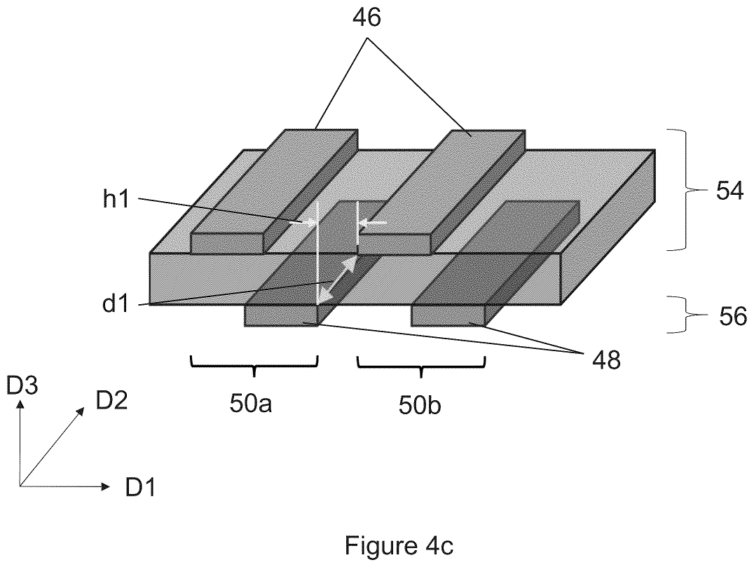

Turning now to FIG. 5, the coil 40 is illustrated in plan view with the first continuous wire strand 46 on the PCB 42 clearly illustrated.

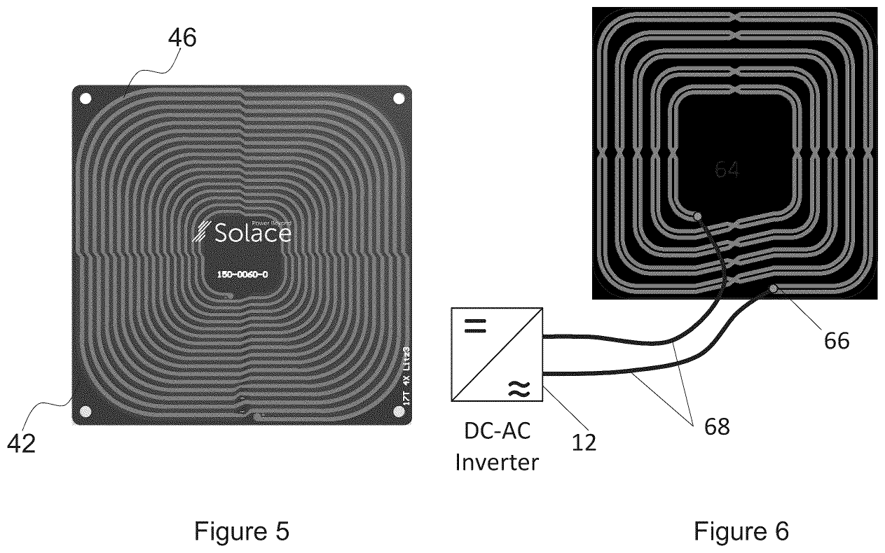

Turning now to FIG. 6, the coil 40 is illustrated connected to the described DC/AC inverter 12. The coil 40 includes a first terminal 64 at one end of the planar Litz wire 44, and a second terminal 66 at the other end of the planar Litz wire 44. These terminals 64, 66 may take the form of PCB pads. The terminals 64, 66 are connected to the DC/AC inverter 12. In the illustrated arrangement, the terminals 64, 66 are connected via wire 68, e.g., solid wire, to the DC/AC inverter 12. As described, the DC/AC inverter 12 provides an AC signal which is utilised to drive the coil 40 to generate a magnetic field from which power may be extracted.

While the coil 40 has been described as being connected to the DC/AC inverter 12 and operating a transmitter coil, one of skill in the art will appreciate, the coil 40 may alternatively, and/or additionally, be connected to the AC/DC rectifier 18 and utilised to extract power via magnetic field coupling. In other words, the coil 40 may form part of a receiver of a wireless power transfer system.

Simulations were preformed of the wireless power transfer system 2 at various loads and separation distances between the transmitter and receiver coils 14, 16. For the purposes of the simulations, the system 2 comprises a power source 8 having a 24 V DC output voltage, and a 12 V DC load 22. The system 2 has a 20 W power rating. The medium 26 between the coils 14, 16 through which power is transferred is an uncoated glass window. In the simulations, the transmitter and receiver coils 14, 16 comprise the described coil 40 having sixteen turns 50. The separation distances between the coils 14, 16 vary from 17 mm, 20 mm, 25 mm, and 30 mm.

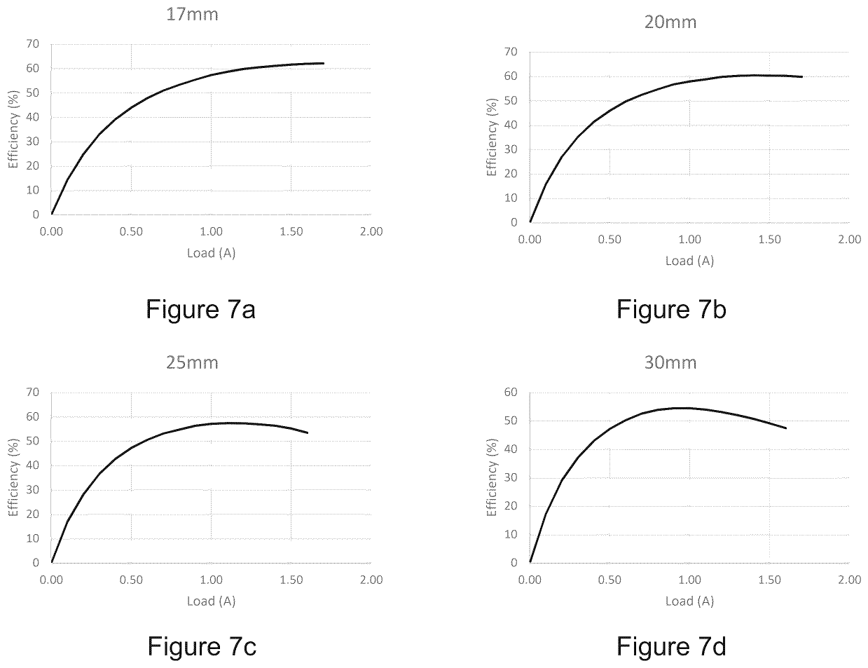

Turning now to FIGS. 7a-7d, graphs of wireless power transfer efficiency relative to load are illustrated at various separation distances of the simulated systems 2. FIG. 7a illustrates efficiency at a separation distance of 17 mm. FIG. 7b illustrates efficiency at a separation distance of 20 mm. FIG. 7c illustrates efficiency at a separation distance of 25 mm. FIG. 7d illustrates efficiency at a separation distance of 30 mm. As illustrated in FIGS. 7a and 7b, as the load current increases the efficiency surpasses 60%. In FIGS. 7c and 7d, the efficiency is maximized at a load current of approximately 1.05 A and 0.95 A, respectively.

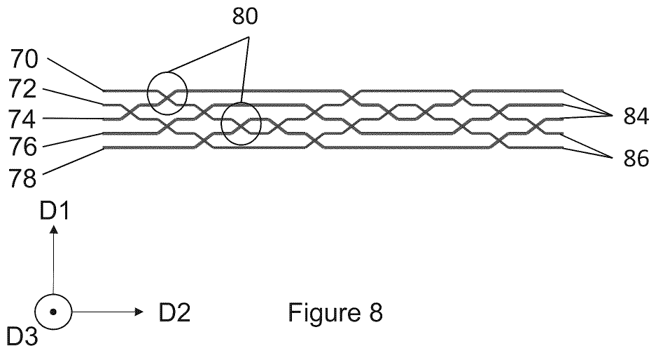

While arrangements have been described in which a coil for wireless power transfer comprises two continuous wire strands, more strands may be present. Turning now to FIG. 8, another arrangement of strands forming a wire, e.g., Litz wire, are illustrated. In this arrangement, a bottom layer 86 comprises first and second continuous wire strands 70, 72. A top layer 84 comprises third, fourth, and fifth continuous wire strands 74, 76, 78. Each strand 70-78 includes multiple lane swaps 80 across the other strands 70-78. The layers 84, 86 and lane swap 80 are the same as the described layers 54, 56 and lane swap 58.

Although embodiments have been described above with reference to the figures, those of skill in the art will appreciate that variations and modifications may be made without departing from the scope thereof as defined by the appended claims.

1. A coil for wireless power transfer, the coil comprising:
a continuous wire strand forming multiple windings in a plane of a printed circuit board (PCB), the multiple windings comprising an innermost winding and an outermost winding enclosing the innermost winding; and
at least one electrical connection to another continuous wire strand forming multiple windings in another plane of the PCB, the electrical connection located intermediate the innermost winding and the outermost winding.

2. The coil of claim 1, wherein a position of the electrical connection is selected such that areas of the windings of the continuous wire strand preceding and following the position are approximately equal.

3. The coil of claim 1, wherein the continuous wire strand comprises at least one lane swap in the plane of the PCB.

4. The coil of claim 3, wherein each winding comprises at least one lane swap.

5. The coil of claim 3, wherein each lane swap reduces or increases a radius of at least one winding of the continuous wire strand.

6. The coil of claim 5, wherein adjacent lane swaps alternatively reduce and increase the radius of at least one winding of the continuous wire strand.

7. The coil of claim 1, wherein the electrical connection comprises at least one via.

8. The coil of claim 7, wherein the electrical connection comprises multiple vias, and wherein the vias are parallel in a plane perpendicular to the plane of the PCB.

9. The coil of claim 1, wherein the coil comprises:
a first continuous wire strand forming multiple windings in a first plane of the PCB, the multiple windings in the first plane comprising an innermost winding and an outermost winding enclosing the innermost winding; and
a second continuous wire strand forming multiple windings in a second plane of the PCB, the multiple windings in the second plane comprising an innermost winding and an outermost winding enclosing the innermost winding.

10. The coil of claim 9, wherein at least one of:
the electrical connection connects the first continuous wire strand to the second continuous wire strand, the electrical connection located intermediate the innermost and the outermost windings of the first continuous wire strand, and intermediate the innermost and the outermost windings of the second continuous wire strand, the first and second planes are parallel, and a distance between the first and second wire strands in the first or second plane is less than an absolute distance between the first and second wire strands.

11. The coil of claim 9, wherein the first continuous wire strand comprises at least one first lane swap in the first plane of the PCB, and wherein the second continuous wire strand comprises at least one second lane swap in the second plane of the PCB.

12. The coil of claim 11, wherein the first lane swap at least partially overlays the second lane swap.

13. A transmitter for wirelessly transferring power to a receiver of a wireless power transfer system, the transmitter comprising:
a power source; and
the coil of claim 1 electrically connected to the power source, the coil for generating a field for transferring power to a receiver of a wireless power transfer system.

14. The transmitter of claim 13, further comprising:
a shield adjacent to the coil and configured to encompass the coil to at least partially eliminate environmental influences affecting the coil.

15. A receiver for wirelessly extracting power from a field generated by a transmitter of a wireless power transfer system, the receiver comprising:
the coil of claim 1, the coil for extracting power from a field generated by a transmitter of a wireless power transfer system; and
a load electrically connected to the coil.

16. The receiver of claim 15, further comprising:
a shield adjacent to the coil and configured to encompass the coil to at least partially eliminate environmental influences affecting the coil.

17. A wireless power transfer system comprising:
a transmitter, the transmitter including
a power source, and
a first coil, the first coil being the coli of claim 1 electrically connected to the power source. the first coil for generating a field for transferring power to a receiver; and
the receiver, the receiver including
a second coil, the second coil being the coil of claim 1, the second coil for extracting power from a field generated by the transmitter, and
a load electrically connected to the second coil.

18. The wireless power transfer system of claim 17, wherein the transmitter and the receiver are separated by a medium.

19. A method of forming a coil for wireless power transfer, the method comprising:
forming a continuous wire strand having multiple windings in a plane of a printed circuit board (PCB), the multiple windings comprising an innermost winding and an outermost winding enclosing the innermost winding; and
forming at least one electrical connection at a location intermediate the innermost winding and the outermost winding for connecting the strand to another continuous wire strand having multiple windings in another plane of the PCB.

20. A method of wirelessly transferring or extracting power, the method comprising:
resonating the coil of claim 1 to generate a field to transfer power to a receiver of a wireless power transfer system; or
resonating the coil of claim 1 to extract power from a field generated by a transmitter of a wireless power transfer system.
